(19) United States
(12) Patent Application Publication
(10) Pub. No.: US 2007/0030965 A1
(43) Pub. Date: Feb. 8, 2007

(54) Methods and apparatuses for management of entitlement to digital security operations

(76) Inventors: Robert Paul Mansz, Rothesay (CA); Curtis Allan Wiseman, New Maryland (CA)

Correspondence Address: James C. Scheller;BLAKELY, SOKOLOFF, TAYLOR & ZAFMAN LLP, Seventh Floor, 12400 Wilshire Boulevard, Los Angeles, CA, 90025, US

(21) Appl. No.: 11/185,191

(22) Filed: Jul. 19, 2005

(51) Int. Cl. H04N 7/167

(52) U.S. Cl. 380/201

(57) ABSTRACT

Methods and apparatuses for management of entitlement to security operations. In one aspect of an embodiment, a method to secure digital content against unauthorized access, includes: receiving a request in a security application to invoke an operation on a digital artefact; and determining an entitlement to the operation in the security application, where the entitlement to the operation is not dependent upon entitlement to the digital artefact. In one embodiment, the entitlement to the operation in the security application is in addition to the entitlement to the digital artefact. In one embodiment, the entitlement to the operation is separate from the entitlement to the digital artefact. In one embodiment, the operation in the security application relates to confidentiality of the digital artefact.

### TECHNOLOGY FIELD

At least some embodiments of the present invention relate to digital security in general, and more particularly to management of entitlement.

### BACKGROUND

Traditionally, security focus is driven by a holistic view: securing measures are implemented to address the entirety of a subject system and to ensure the integrity of the system on a continuous basis (e.g., twenty four hours a day and seven days a week). The application of traditional security technology generally conforms to this view. For example, infrastructural investments in hardware and/or software are made to secure various parties of a communication system and the communication channel used to communicate confidential material (in the form of digital artefacts). For example, even at a consumer level, security requires onerous installation of anti-virus, personal firewall and related technologies in order to achieve a modicum of privacy and confidentiality.

A firewall is typically used to enforce a set of control rules on the network traffic passing through the firewall. A firewall determines the types of network traffic passing through the firewall and selectively blocks or permits certain types of traffic according to the control rules

To support the secure exchange of packets at the Internet Protocol (IP) layer, the Internet Engineering Task Force (IETF) developed a set of protocols called IP Security Protocol (IPsec). IPsec has been used to implement Virtual Private Networks (VPNs). IPsec uses encryption to secure the packets. In a transport mode of IPsec, only the data portion (payload) of each packet is encrypted. In a tunnel mode of IPsec, both the header and the payload are encrypted. When IPsec is used, the sending and receiving devices share a public key for encryption. A protocol known as Internet Security Association and Key Management Protocol/Oakley (ISAKMP/Oakley) can be used to arrange the shared public key. Using ISAKMP/Oakley, the receiver can obtain a public key and authenticate the sender using digital certificates.

A typical digital certificate includes data representing the identity of the certificate holder (e.g., name, email address of the certificate holder), dates of validity of the certificate, and a public key that can be used to verify the digital signature of the holder. The digital certificate is typically issued and digitally signed by a trusted entity; and a public key of the trusted entity can be used to verify the digital signature on the digital certificate.

### SUMMARY OF THE DESCRIPTION

Methods and apparatuses for management of entitlement to security operations are described here. Some of the embodiments of the present invention are summarized in this section.

In one aspect of an embodiment of the present invention, a method to secure digital content against unauthorized access, includes: receiving a request in a security application to invoke an operation on a digital artefact; and determining an entitlement to the operation in the security application, where the entitlement to the operation is not dependent upon the entitlement to the digital artefact (e.g., the entitlement to the operation can be determined regardless whether the user is entitled to the digital artifact, or before the entitlement to the digital artefact is determined). In one embodiment, the entitlement to the operation in the security application is in addition to the entitlement to the digital artefact. In one embodiment, the entitlement to the operation is separate from the entitlement to the digital artefact. In one embodiment, the operation in the security application relates to confidentiality of the digital artefact.

In one example of an embodiment, the operation in the security application includes specifying entitlement to the digital artefact for protection against unauthorized access, encrypting at least a portion of the digital artefact, and/or storing a portion of the digital artefact on a network based server in an encrypted form, etc.

In one example of an embodiment, the operation in the security application includes determining entitlement to the digital artefact, authenticating access to the digital artefact according to the entitlement to the digital artefact, and/or decrypting the digital artefact in accordance with the entitlement to the digital artefact.

In one example of an embodiment, the method further includes: charging an account to obtain the entitlement to the operation on the digital artefact in the security application. For example, the account may be charged one of: a per-use fee; a subscription fee for a period of time; and a fee based at least partially on a size of the digital artefact.

In one example of an embodiment, an amount is purchased for the account, which is to be debited for the entitlement to an operation in the security application (e.g., on a per-use, per-instant, or transient basis).

In one example of an embodiment, the security application runs on a mobile device; and the digital artefact includes a Short Message Service (SMS) message, or a Multimedia Message Service (MMS) message, or an email message, or an instant message, or a file, or details of a financial or commerce transaction, or other information. In general, the security application can run on other devices, such as desktop computers, information terminals, etc. For example, the security application can be applied to the connected, desktop or back-office world as well.

In one example of an embodiment, the mobile device includes a cellular/wireless communication device; the mobile device has an account chargeable for telecommunication usage; and the account is further chargeable for the entitlement to operations of the security application regardless of (or independent from) the entitlement to digital artefact to be operated on. In one example, the account is charged on a per-use basis, or a per-instant basis, or other transient basis.

The present invention includes methods and apparatuses which perform these methods, including data processing systems which perform these methods, and computer readable media which when executed on data processing systems cause the systems to perform these methods.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows an example of a security system to protect digital content against unauthorized access according to one embodiment of the present invention.

FIG. 2 shows a method to manage entitlement to security operations of a security application according to one embodiment of the present invention.

FIG. 3 shows a method to manage entitlement to creating an access protected digital artefact according to one embodiment of the present invention.

FIG. 4 shows a method to manage entitlement to determining entitlement to an access protected digital artefact according to one embodiment of the present invention.

FIG. 5 shows an example of securing the transmission of a message according to one embodiment of the present invention.

FIG. 6 shows a block diagram example of a data processing system which may be used with the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

One embodiment of the present invention provides a system and method for managing the entitlement to methods, which can be used to secure a digital artefact (e.g., for confidentiality and/or privacy) and associated attributes that describe the permissible usage of the digital artefact (e.g., digital rights).

In one embodiment, an automated system is used to control the access to, and/or the use of, the cryptographic and rights-management functions of a security application. These functions are designed to secure a digital artefact (e.g., during transmission over a communication channel, such as a cellular telecommunication link) and to govern its use according to some rules (e.g., digital rights).

In one embodiment, the system fulfills a request for an entitlement associated with securing a digital artefact on behalf of an entitlement requesting user. In one embodiment, the entitlement requesting user has associated unique identification attributes; and the system charges the user according to the unique identification attributes, or consumes the pre-purchased tokens or accounts of the user, to fulfill the request for such an entitlement.

Traditionally, a security package (e.g., firewall or VPN application) is purchased and installed. Once installed, the security package is used on a continuous basis (e.g., twenty-four hours a day and seven days a week).

A refined view of securing data communication indicates that a transient application of security limited to the time frame over which the communication is conducted may be adequate.

In one embodiment of the present invention, entitlement to the confidentiality can be requested on an as-needed basis. Securing mechanisms are applied in accordance with the entitlement that has been granted.

In one embodiment, the entitlement to the confidentiality can be enforced in addition to, or in combination with, the entitlement to the digital artefact (underlying rights associated to the digital artefact).

In general, access to the securing mechanisms to manage the entitlement of a digital artefact (e.g., digital rights) can also be subject to entitlement as well. Traditionally, granting the entitlement to the securing mechanisms has always been managed from the holistic perspective. To protect the entirety of a subject system on a continuous basis, a user purchases a security package, which is then used on an indiscriminate basis once it is paid for, so that the protection is provided in a holistic approach.

In one embodiment of the present invention, a transactional perspective is incorporated into the securing mechanisms so that the entitlement to use the securing mechanism (e.g., for confidentiality) is granted on a per-use, per-instance, or transient manner.

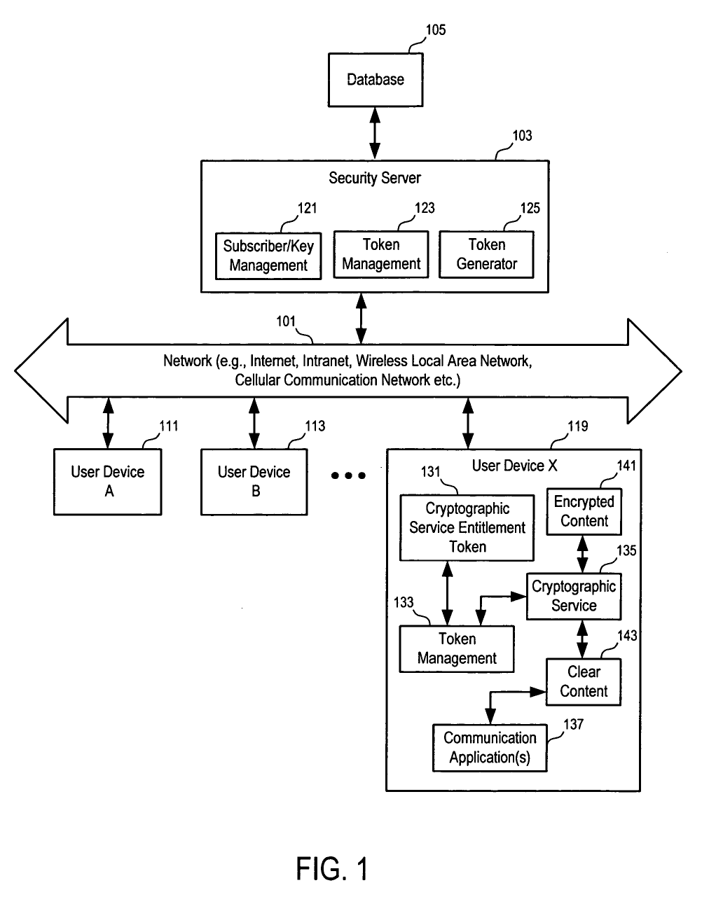

FIG. 1 shows an example of a security system to protect digital content against unauthorized access according to one embodiment of the present invention.

In FIG. 1, a security server (103) is used to provide security related services to user devices (e.g., 111, 113, . . . , 119) over the network (101). The network can include Internet, intranet, wireless local area network, cellular communication network, etc. The user devices may include cellular phones, personal digital assistant (PDA), handhold computers, notebook computers, network computers, desktop computers, etc. Typically, one user device sends data content to another user device over the network (e.g., through email, instant messaging, Short Message Service (SMS), Multimedia Message Service (MMS)). Alternatively, one user device may simply protect the data content on the same device for privacy/confidentiality without transmitting to another device.

In one embodiment of the present invention, a typically user device (119) includes a cryptographic service (135) which is capable of encrypting the clear content (143) into the encrypted content (141) and/or decrypting the encrypted content (141) into the clear content (143), which is not encrypted.

In one embodiment, the communication application(s) (137) can selectively use the cryptographic service (135) according to user requests on an as-needed based.

In one embodiment of the present invention, the cryptographic service (135) not only encrypts the content but also embeds entitlement information with the encrypted content so that information indicating the entities who are entitled to the content and their corresponding rights is combined with the encrypted content. Thus, the information about the entitlement to the encrypted content travels with content. Alternatively, the information about the entitlement to the encrypted content can be specified separately from the encrypted content. For example, in one embodiment, the information about the entitlement to the encrypted content is maintained by the security server (103) and stored in the database (105).

In one embodiment of the present invention, the cryptographic service (135) extracts a portion of the content for storage in the database (105). The security server (103) maintains the extracted portion which is encrypted using the most current cryptographic mechanism. The encrypted content does not contain the complete content. Thus, without the portion secured on the security server, the clear content cannot be recovered from only the encrypted content (141). In one embodiment, the portion secured on the security server is encrypted adaptively according to the state of the art of cryptography.

In one embodiment of the present invention, the entitlement to the use of the cryptographic service (135) is managed in a transient manner. In the example of FIG. 1, a token management (133) is used to control the operation of cryptographic service (135). When the user device has a valid cryptographic service entitlement token (131), the user can operate the cryptographic service (135) to encrypt or decrypt. In one embodiment, the token is consumable. The user can purchase tokens to operate the cryptographic service (135) on an as-needed basis.

In one embodiment, an encryption operation is charged on a per-use basis, or a per-instant basis, or based on the size of the content to be encrypted, or a combination of these.

In one embodiment, a decryption operation is charged on a per-use basis, or a per-instant basis, or based on the size of the content to be encrypted, or a combination of these.

In one embodiment, the system charges for either the encryption operation or the decryption operation. Alternatively, the system charges for the encryption operation as well as for the decryption operation.

In one embodiment, the user device has an account (e.g., a pre-paid card) which can be charged for the entitlement token. The account may be operated locally at the user device (e.g., using a smart card). Alternatively, the account may be maintained at a database remote to the user device (e.g., in database 105). Alternatively, the entitlement token may be purchased through various payment schemes, such as credit accounts, debit accounts, bank accounts, phone accounts, etc.

In one embodiment of the present invention, the security server (103) performs subscriber/key management (121). For example, the security server (103) can maintain the information about the users and the corresponding key information for authenticate the users. The identity of the user can be authenticated using password, digital signature, and other methods. In one embodiment of the present invention, the security server (103) performs the authentication tasks for the user devices to enforce the entitlement to digital artefacts, to enforce the entitlement to cryptographic services and/or to supply entitlement tokens.

In one embodiment of the present invention, the security server (103) has a token generator (125) which can generate tokens that represent entitlement to the cryptographic service (e.g., 135). In one embodiment, the token management (123) on the security server (103) is used to distribute the tokens and manage financial transactions. For example, when a payment from a user device is accepted, the token generator (125) can generate a token for the user device. The token specifies the entitlement of the user (or the device) to the operation of the cryptographic service (e.g., 135).

For example, the token may specify the number of cryptographic operations purchased; and the token management (e.g., 133 on the user device) decreases the number of cryptographic operations purchased after each use of a cryptographic operation.

Alternatively, the token may specify the amount purchased; and the token management (e.g., 133 on the user device) deducts an amount from the token after each use of a cryptographic operation.

Alternatively, the token may specify a number of points purchased; and the token management (e.g., 133 on the user device) deducts a number of points from the token after each use of a cryptographic operation.

In one embodiment, a token is specific for a particular user. User authentication is performed for the use of the token.

In one embodiment, the tokens are access protected in a way similar to other digital contents. For example, the tokens can include entitlement information embedded within the tokens. In one embodiment, the cryptographic service (e.g., 135) does not need a further token to authorize the operation on the cryptographic service entitlement tokens.

Alternatively, the entitlement to the use of cryptographic server is requested and granted through network communication with the security server (103).

In one embodiment, the presence of the security server (103) is not necessary for the operation of the cryptographic service for the communication between user devices (e.g., 111, 119). For example, the entitlement tokens may be provided through a smart card; and the cryptographic services on the user devices also perform the authentication tasks.

For example, the user device may include a cellular telecommunication transceiver; and the entitlement to the cryptographic service can be charged on the account (e.g., on a smart card) that is typically charged for telecommunication usages.

In one embodiment, the cryptography service (e.g., 135) is used to protect the content locally on the same device. For example, a file can be encrypted and access protected on the same device for privacy/confidentiality.

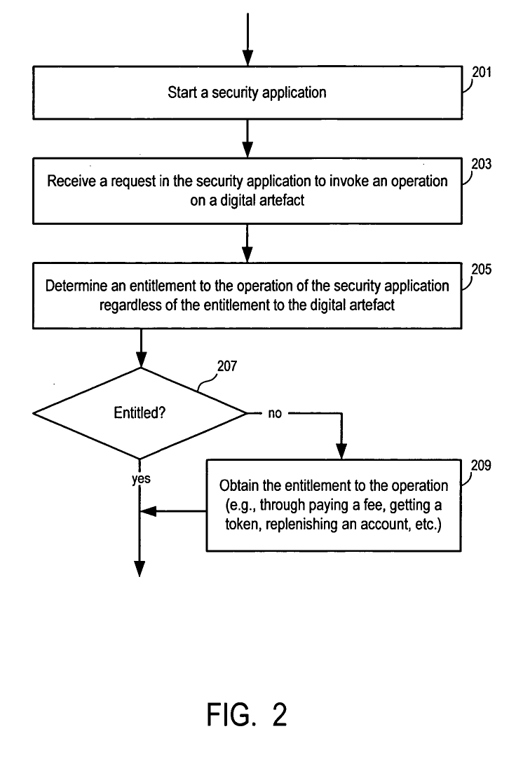

FIG. 2 shows a method to manage entitlement to security operations of a security application according to one embodiment of the present invention. In FIG. 2, operation 201 starts a security application. In one embodiment, the security application can provide security protections against unauthorized access to confidential information through the use of cryptography.

After operation 203 receives a request in the security application to invoke an operation on a digital artefact (e.g., to encrypt or to decrypt the digital artefact), operation 205 determines an entitlement to the operation of the security application regardless of the entitlement to the digital artefact. For example, the entitlement to the operation can be determined before the entitlement to the digital artefact is determined. The entitlement to the operation can be independent from the entitlement to the digital artefact. For example, the entitlement to the operation can be determined in order to determine the entitlement to the digital artefact. If operation 207 determines that the user is not entitled to the operation, operation 209 obtains the entitlement to the operation (e.g., through paying a fee, getting a token, replenishing an account, etc.).

In one embodiment, after the entitlement to the requested operation of the security application (e.g., decryption) is obtained, the security application examines the entitlement to the digital artefact.

Alternatively, the security application verifies the entitlement to the digital artefact before the entitlement to the security operation (e.g., decrypting the digital artefact).

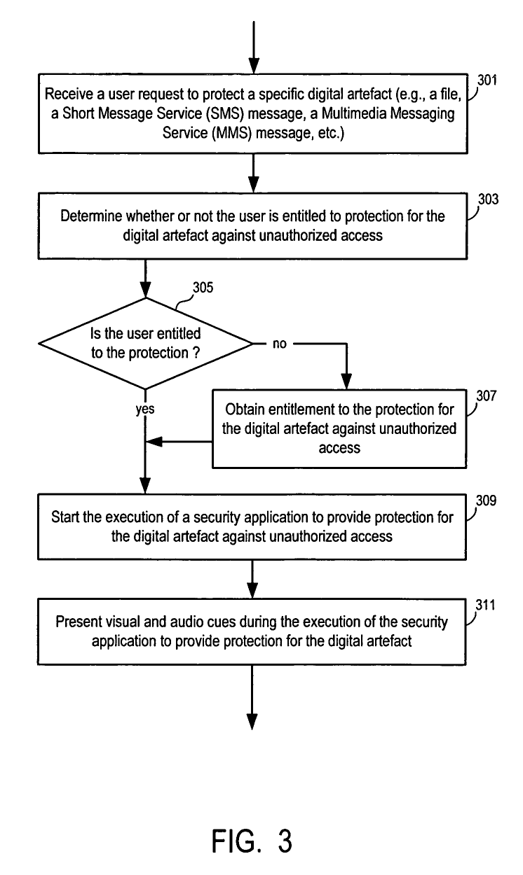

FIG. 3 shows a method to manage entitlement to creating an access protected digital artefact according to one embodiment of the present invention.

After operation 301 receives a user request to protect a specific digital artefact (e.g., a file, a Short Message Service (SMS) message, a Multimedia Messaging Service (MMS) message, etc.), operation 303 determines whether or not the user is entitled to protection for the digital artefact against unauthorized access. In one embodiment, the protection is provided through encryption for privacy/confidentiality.

If operation 305 determines the user is not entitled to the protection, operation 307 obtains entitlement to the protection for the digital artefact against unauthorized access (e.g., through a purchasing operation).

After verifying that the user is entitled to the protection for the digital artefact, operation 309 starts the execution of a security application to provide protection for the digital artefact against unauthorized access. In one embodiment, operation 311 further presents visual and audio cues during the execution of the security application to provide protection for the digital artefact. In one embodiment, the visual and audio cues are designed to provide preconscious feeling security for people of a particular culture. Further details about the visual and audio cues can be found in a co-pending U.S. patent application (attorney docket no. 07363.P001), which is hereby incorporated herein by reference.

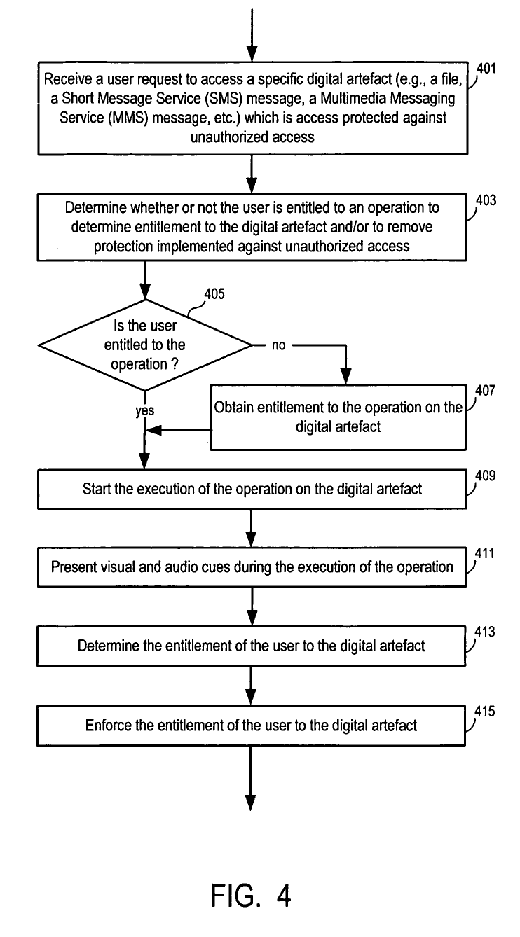

FIG. 4 shows a method to manage entitlement to determining entitlement to an access protected digital artefact according to one embodiment of the present invention.

After operation 401 receives a user request to access a specific digital artefact (e.g., a file, a Short Message Service (SMS) message, a Multimedia Messaging Service (MMS) message, etc.) which is access protected against unauthorized access, operation 403 determines whether or not the user is entitled to an operation to determine entitlement to the digital artefact and/or to remove protection implemented against unauthorized access.

If operation 405 determines that the user is not entitled to the operation for security, operation 407 obtains entitlement to the operation on the digital artefact (e.g., through a purchasing operation).

After verifying that the user is entitled to the operation, operation 409 starts the execution of the operation on the digital artefact. In one embodiment, operation 411 further presents visual and audio cues during the execution of the operation.

In one embodiment, operation 413 determines the entitlement of the user to the digital artefact; and operation 415 enforces the entitlement of the user to the digital artefact. For example, when the user is entitled to the digital artefact (e.g., through an authentication process involving the verification of a password, a secret key, or a digital signature), the system decrypts the digital artefact for the user.

Alternatively, the entitlement of the user to the digital artefact is determined first. When the user is entitled to the digital artefact, the entitlement to the decryption operation is then determined (and purchased when required).

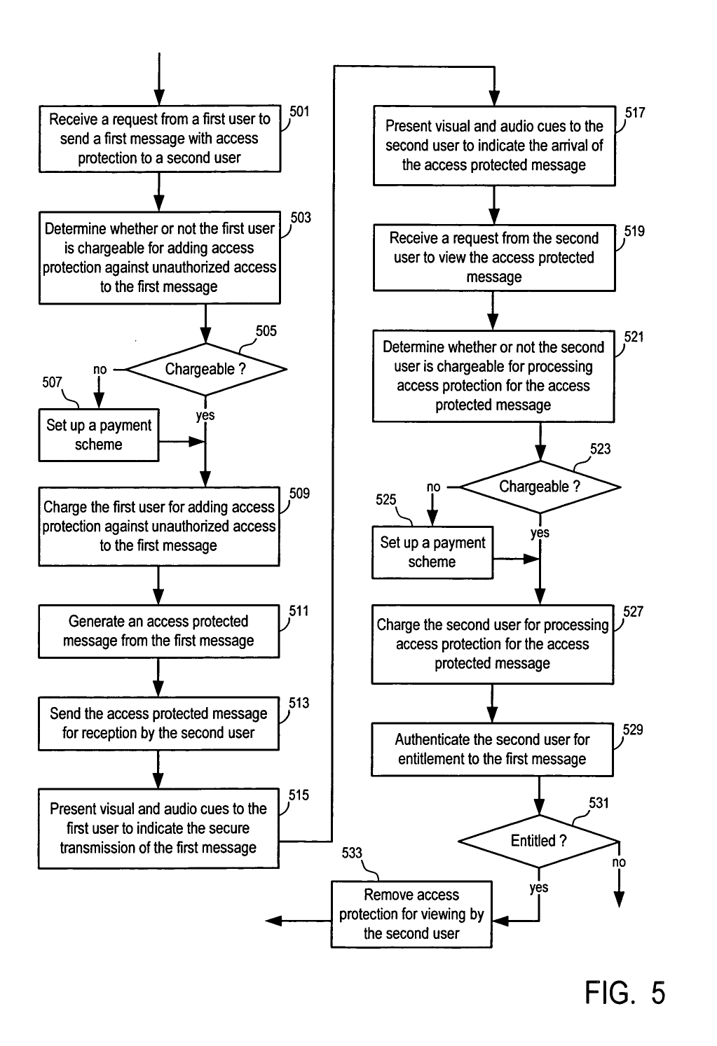

FIG. 5 shows an example of securing the transmission of a message according to one embodiment of the present invention. For example, when the message is transmitted over a physical communication medium which is not necessarily secure (e.g., Internet, wireless network connection, cellular communication connection, etc.), methods of embodiments of the present invention secures the message that is being transmitted against authorized usage.

In FIG. 5, after operation 501 receives a request from a first user to send a first message with access protection to a second user, operation 503 determines whether or not the first user is chargeable for adding access protection against unauthorized access to the first message.

If operation 505 determines that the first user is not chargeable, operation 507 sets up a payment scheme.

Operation 509 charges the first user for adding access protection against unauthorized access to the first message. For example, an amount in an account (e.g., the entitlement token, a credit account, a debit account, a bank account, etc.) of the first user can be modified for the charge.

After the first user purchases the entitlement to the protection, operation 511 generates an access protected message from the first message (e.g., through asymmetric encryption with one-time user key pairs, extracting a portion for storage on the security server and encryption, etc.). Operation 513 sends the access protected message for reception by the second user. Operation 515 presents visual and audio cues to the first user to indicate the secure transmission of the first message.

When the access protected message arrives at the device of the second user, operation 517 presents visual and audio cues to the second user to indicate the arrival of the access protected message.

After operation 519 receives a request from the second user to view the access protected message, operation 521 determines whether or not the second user is chargeable for processing access protection for the access protected message.

If operation 523 determines that the second user is not chargeable, operation 525 sets up a payment scheme. Operation 527 charges the second user for processing access protection for the access protected message.

Operation 529 authenticates the second user for entitlement to the first message. If operation 531 determines the second user is entitled to the first message, operation 533 removes access protection for viewing by the second user. If operation 531 determines the second user is not entitled to the first message, the second user may be offered the chance to re-try the authentication process or may be denied access to the message.

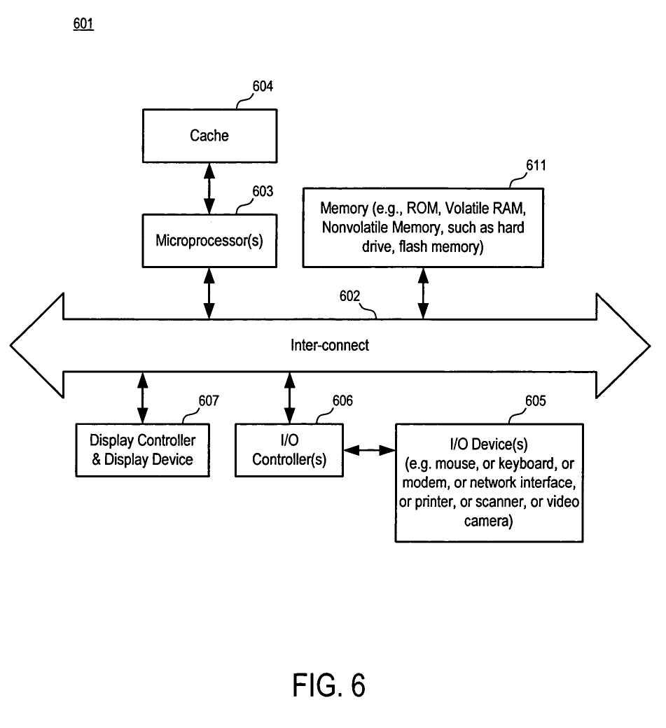

FIG. 6 shows a block diagram example of a data processing system which may be used with the present invention. Note that while FIG. 6 illustrates various components of a computer system, it is not intended to represent any particular architecture or manner of interconnecting the components. It will also be appreciated that network computers and other data processing systems, such as a handhold computer, a personal digital assistance, or a cellular phone, which have fewer or more components may also be used with the present invention.

In FIG. 6, the communication device (601) is a form of a data processing system. The system (601) includes an inter-connect (602) (e.g., bus and system core logic), which interconnects a microprocessor(s) (603) and memory (611). The microprocessor (603) is coupled to cache memory (604) in the example of FIG. 6.

The inter-connect (602) interconnects the microprocess(s) (603) and the memory (611) together and also interconnects them to a display controller and display device (607) and to peripheral devices such as input/output (I/O) devices (605) through an input/output controller(s) (606). Typical I/O devices include mice, keyboards, modems, network interfaces, printers, scanners, video cameras and other devices which are well known in the art.

The inter-connect (602) may include one or more buses connected to one another through various bridges, controllers and/or adapters. In one embodiment the I/O controller (606) includes a USB (Universal Serial Bus) adapter for controlling USB peripherals, and/or an IEEE-1394 bus adapter for controlling IEEE-1394 peripherals.

The memory (611) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment of the present invention, a server data processing system as illustrated in FIG. 6 is used as the security server (e.g., 103 in FIG. 1). In one embodiment of the present invention, a data processing system as illustrated in FIG. 6 is used as a user device (e.g., 119 in FIG. 1), which may include more or less components. A data processing system as the user device can be in the form of a PDA, a cellular phone, a notebook computer, a personal desktop computer, etc.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While some embodiments of the invention have been described in the context of fully functioning computers and computer systems, those skilled in the art will appreciate that various embodiments of the invention are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others, and transmission type media such as digital and analog communication links for electrical, optical, acoustical or other forms of propagated signals, such as carrier waves, infrared signals, digital signals, etc.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine readable medium containing executable computer program instructions which when executed by a data processing system cause said system to perform a method to secure digital content against unauthorized access, the method comprising:
receiving a request in a security application to invoke an operation on a digital artefact; and
determining an entitlement to the operation in the security application, wherein the entitlement to the operation is not dependent upon entitlement to the digital artefact.

2. The medium of claim 1, wherein the operation in the security application relates to confidentiality of the digital artefact.

3. The medium of claim 1, wherein the operation includes specifying entitlement to the digital artefact for protection against unauthorized access.

4. The medium of claim 3, wherein the operation further includes encrypting at least a portion of the digital artefact.

5. The medium of claim 4, wherein the operation further includes storing a portion of the digital artefact on a network based server in an encrypted form.

6. The medium of claim 1, wherein the operation includes determining entitlement to the digital artefact.

7. The medium of claim 6, wherein the operation further includes authenticating access to the digital artefact according to the entitlement to the digital artefact.

8. The medium of claim 7, wherein the operation further includes decrypting the digital artefact in accordance with the entitlement to the digital artefact.

9. The medium of claim 1, wherein the method further comprises:
charging an account to obtain the entitlement to the operation on the digital artefact in the security application.

10. The medium of claim 1, wherein the security application runs on a mobile device; and the digital artefact comprises one of:
a Short Message Service (SMS) message; and
a Multimedia Message Service (MMS) message.

11. The medium of claim 10, wherein the mobile device comprises a wireless communication device; the mobile device has an account chargeable for telecommunication usage; and the account is further chargeable for entitlement to operations of the security application regardless of entitlement to digital artefact to be operated on.

12. A method to secure digital content against unauthorized access, the method comprising:
receiving a request in a security application to invoke an operation on a digital artefact; and
determining an entitlement to the operation in the security application, where the entitlement to the operation is not dependent upon entitlement to the digital artefact.

13. The method of claim 12, further comprising:
performing the operation after obtaining the entitlement to the operation to enforce privacy and confidentiality.

14. The method of claim 13, wherein said performing the operation comprises:
specifying entitlement to the digital artefact for protection against unauthorized access; and
encrypting at least a portion of the digital artefact.

15. The method of claim 13, wherein said performing the operation comprises:
decrypting the digital artefact in accordance with the entitlement to the digital artefact.

16. The method of claim 12, further comprising:
charging an account to obtain the entitlement to the operation on the digital artefact in the security application.

17. The method of claim 16, wherein the account is charged one of:
a per-use fee;
a subscription fee for a period of time; and
a fee based at least partially on a size of the digital artefact.

18. The method of claim 16, further comprising:
purchasing an amount for the account, the account to be debited for the entitlement to an operation in the security application.

19. The method of claim 12, wherein the security application runs on a mobile device with a cellular communication transceiver; and the digital artefact comprises one of:
a Short Message Service (SMS) message; and
a Multimedia Message Service (MMS) message.

20. The method of claim 19, wherein the mobile device has an account chargeable for telecommunication usage; and the account is further chargeable for entitlement to operations of the security application regardless of entitlement to digital artefact to be operated on.

21. A data processing system to secure digital content against unauthorized access, the system comprising:
means for receiving a request in a security application to invoke an operation on a digital artefact; and
means for purchasing an entitlement to the operation in the security application, the entitlement to the operation being separate from entitlement to the digital artefact.

22. The system of claim 21, wherein the operation includes specifying entitlement to the digital artefact for protection against unauthorized access, encrypting at least a portion of the digital artefact, and storing a portion of the digital artefact on a network based server in an encrypted form.

23. The system of claim 21, wherein the operation includes determining entitlement to the digital artefact, authenticating access to the digital artefact according to the entitlement to the digital artefact, and decrypting the digital artefact in accordance with the entitlement to the digital artefact.

24. The system of claim 21, wherein the entitlement to the operation is purchased through one of:
a per-use fee;
a subscription fee for a period of time; and
a fee based at least partially on a size of the digital artefact.

25. The system of claim 21, further comprises:
a cellular communication transceiver;
wherein the digital artefact comprises one of:
a Short Message Service (SMS) message; and
a Multimedia Message Service (MMS) message.

26. The system of claim 25, wherein the system has an account chargeable for telecommunication usage; and the account is further chargeable for entitlement to operations of the security application.
